(19) United States
(12) Patent Application Publication
(10) Pub. No.: US 2008/0233403 A1
(43) Pub. Date: Sep. 25, 2008

(54) Method of Making Ceramic Reactor Components and Ceramic Reactor Component Made Therefrom

(76) Inventors: Timothy Dyer, Auburn, CA (US); Ho Ouk, Auburn, CA (US); Louis Everett Jensen, Auburn, CA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/026,806

(22) Filed: Feb. 6, 2008

Related U.S. Application Data
(60) Provisional application No. 60/888,597, filed on Feb. 7, 2007.

(51) Int. Cl. B32B 3/00; B28B 11/08; B29C 59/14; B32B 18/00

(52) U.S. Cl. 428/409; 264/293; 264/238; 264/483

(57) ABSTRACT

A method of improving the adhesion of processing materials on a ceramic component is described. The method includes the steps of forming a green ceramic component and texturing the surface of the green ceramic component. The as-textured component is then fired to harden the ceramic material. In an alternative embodiment of the method, a coating is applied to the surface of the as-fired ceramic component to provide a secondary adhesion layer. A ceramic component for use in an etching or deposition reactor chamber is also described. The ceramic component includes a substrate formed of a ceramic material and has a textured surface formed thereon such that the textured surface has a roughness of about 100 to 1000 μin Rₐ.

### FIELD OF THE INVENTION

This invention relates to the manufacture and restoration of components used in semiconductor reactors, and in particular to a process for providing a roughened surface on such a component that provides improved adhesion of metallized or other residue layers.

### BACKGROUND OF THE INVENTION

Twin Wire Arc Spray (TWAS) aluminum (Al) and plasma sprayed ceramic films are commonly used to coat surfaces of semiconductor reactor components. These films increase component life by increasing the surface roughness. During the TWAS process pure Al is atomized with an electric arc made by the junction of two wires and transported to a substrate by an air jet. The wires are the source of the aluminum deposition. The plasma spray process is used to deposit Al, alumina, titania, yttria, and zirconia films using powdered raw materials and air or nitrogen as a propellant. FIG. 1 illustrates an example of a PVD Film/TWAS/Roughened Alumina stack arrangement 10. The stack 10 is formed on a substrate 12 that is made of a metal, quartz, or a ceramic material. A ceramic layer 14 is applied over the substrate 12. A TWAS layer 16 is formed over the ceramic layer 14 and a PVD film 18 is deposited over the TWAS layer. In general, those films provide surfaces that are rough, typically having a surface roughness of about 300 to 1200 μin. Rₐ.

Abrasive media blasting has been used to roughen the surface of ceramic coated chamber components as well. Because of the hardness of alumina ceramics, the roughness of the applied surfaces is usually limited to less than 100 μin Rₐ when using abrasive media blasting. This low roughness limits TWAS and plasma spray film adhesion to ceramic surfaces. The roughened surfaces are used to capture deposition and process byproducts and residues for silica films deposited by CVD or HDPCVD, metal films deposited by PVD, SiP, and IMP PVD such as Al, Cu, Ta, TaN, Ti, TiN, Ni, W, and etch byproducts generated from wafer plasma cleaning and dry etching such as Al, silica, metal oxide, and polysilicon-etch processes.

Schutze, “Failure of Oxide Scales on Advanced Materials Due to the Presence of Stresses”, High Temperature Corrosion of Advanced Materials and Protective Coatings, Elsevier Science Pub. (1992) teaches that the ideal surface is a sinusoidal surface with a high peak to valley amplitude. A high peak to valley surface wave form (roughness) allows compressive stresses to be translated from tensile delaminating forces into shear forces. Brittle solids, such as reactor residues or plasma sprayed films, are stronger in shear than tension. Therefore, a high amplitude, rough, and wavy film provides the best anchor for these compressive films. In addition, CVD, PVD, and etch film residues nucleate heterogeneously on the surfaces of ceramic components. They also nucleate in the same manner on TWAS coated or plasma sprayed film surfaces. Heterogeneous nucleation relies on sharp pointed surfaces (asperities) to start film growth from the gas phase. Sharper points stimulate nucleation and a large regular and dense array of asperities will promote uniform film growth over the substrate. Therefore, the ideal surface for residue growth and adhesion is a high amplitude, high frequency wavy surface with a consistent roughness throughout. Ideal surface texture traits for residue adhesion are a uniform surface with a roughness greater than 400 u-inches Ra and peak to valley roughness ranging from 2000 to 5000 u-in.

Rough surfaces enhance deposition (process product or byproduct) residue adhesion on plasma based reactor components by altering surface stresses which in turn reduce debonding/buckling forces imposed on the surface. Holding more film residues leads to increased service life of the component inside the chamber. A rough surface reduces buckling forces by transforming tensile stresses that tend to pull off film residues, into shear forces. Since these residues are brittle in nature, they are stronger in shear than they are in tension. Compressive deposition products and byproducts can be found on components of CVD, PVD, or etch chambers. These components can be chamber shields, rings around the cathode where Si wafers are being coated, and/or process bell jars. Ring shaped components used around the wafer include deposition rings, clamp rings, and cover rings. FIGS. 2A to 2D show examples of ceramic components. More specifically, FIG. 2A shows an alumina dome, FIG. 2B shows a focus ring, FIG. 2C shows an edge ring, and FIG. 2D shows a side shield. The components are etched clear of deposited residues (cleaned) periodically when the deposits become too thick. Due to the compressive stress nature of the reactor residues, eventually interface stresses between the TWAS or plasma-sprayed material and the deposition (or component) surface can become high enough to lift the TWAS or plasma sprayed film off of the ceramic components. This results in spalling or compressive-stress driven film delamination of the residue and the rough bonding layer. Therefore, the adhesion of the rough surface film and/or process residue layer to the reactor component limits the service life of the reactor component.

Among the important requirements for long service life for the deposition or etch component are good acid corrosion resistance after multiple cleanings and high roughness for maximum process residue adhesion. The process according to the present invention provides acid-resistant roughened alumina or zirconia reactor components having a textured surface that can increase both TWAS and process residue adhesion.

Adhesion of TWAS and plasma spray films to alumina components is generally weak chemically and predominantly mechanical in nature. Zirconia offers better TWAS adhesion because it is easier to roughen its surface by bead blasting. Zirconia is also advantageous because it has a chemical affinity for aluminum. One of the major concerns with TWAS is its adhesion to alumina. It is common practice to bead-blast hardened alumina and zirconia to provide texture. However, because of the high hardness of those materials, it is impossible to abrasively roughen such substrates to greater than 50 μin Rₐ without creating significant sub-surface damage. Even at a roughness of 50 μin Rₐ, some subsurface damage is created in the alumina. During the bead blasting process, surface defects are also introduced in the alumina. Such defects cause particulate contamination during wafer processing and promote cohesive failures of the TWAS/alumina surface as film processing residues build up. One attempted solution to that problem has been to anneal the alumina after bead blasting. However, annealing cannot repair large sub-surface defects.

### SUMMARY OF THE INVENTION

The disadvantages of the known methods and articles as described above are resolved to a significant degree by the method and article provided by the present invention. In accordance with a first aspect of the present invention, there is provided a method of improving the adhesion of processing materials on a ceramic component. The method includes the steps of forming a green ceramic component and texturing the surface of the green ceramic component. The as-textured component is then fired to harden the ceramic material.

In accordance with a second aspect of the present invention there is provided a further method of improving adhesion of processing materials on a ceramic component. The method includes the steps of forming a green ceramic reactor component and texturing the surface of the green ceramic component. The as-textured component is then fired to densify and harden the ceramic material. A coating is then applied to the surface of the as-fired ceramic component to provide a secondary adhesion layer.

In accordance with a third aspect of the present invention there is provided a component for use in an etching or deposition reactor chamber comprising. The component according to this aspect of the invention includes a substrate formed of a ceramic material. The substrate has a textured surface formed thereon wherein the textured surface has a roughness of about 100 to 1000 μin Rₐ.

### BRIEF DESCRIPTION OF THE DRAWINGS

The foregoing summary as well as the following detailed description will be better understood when read with reference to the drawings, wherein:

FIG. 1 is a schematic illustration of a partial cross section of a known type of layered component;

FIGS. 2A to 2D are photographs of known ceramic components used in semiconductor circuit processing chambers;

FIG. 2E is a photograph of a ceramic component that has been processed according to the present invention;

FIG. 3 is a flow diagram of an embodiment of the process according to the present invention;

FIG. 4 is a photomicrograph of a partial cross section of a ceramic component that was processed in accordance with the present invention;

FIG. 5 is a schematic representation of an arrangement for a collimating device used in the process according to this invention;

FIGS. 6A and 6B are partial schematic representations of geometries for the cells of the collimating device of FIG. 5;

FIG. 7 is a photograph (15× magnification) of a portion of a surface of a ceramic component made in accordance with the present invention; and

FIG. 8 is a photomicrograph (100× magnification) of a partial cross section of a ceramic component having a secondary adhesion layer in accordance with the present invention.

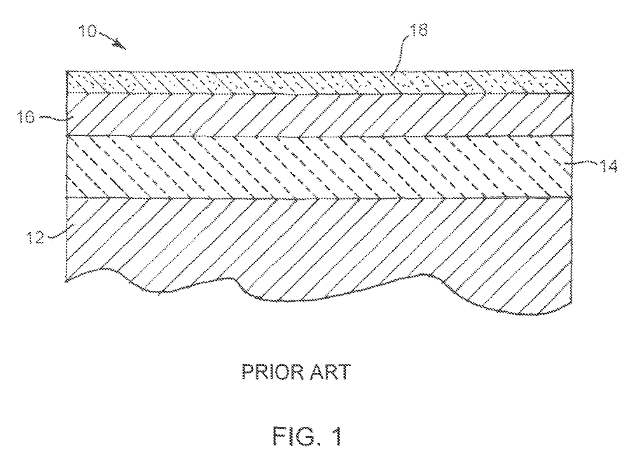

### DETAILED DESCRIPTION

The process according to the present invention permits the manufacturing of alumina and zirconia components (domes, rings, shields, etc.) with improved adhesion for TWAS, plasma spray, and/or other reactor process residues. Improving such adhesion will increase component service lifetimes. The TWAS/residue adhesion is improved by texturing the ceramic component surface while the ceramic is in the green state, i.e., prior to firing. This can be completed with minimal subsurface damage when component surfaces are soft and polymeric in nature. The texture is then fired into the component and preserved for multiple component recycles because the ceramic material provides excellent acid corrosion resistance. The as-fired substrate has a textured surface formed thereon wherein the textured surface has a roughness of about 100 to 1000 μin Rₐ. Preferably, the textured surface has a roughness of at least about 150 μin. Rₐ, and better yet, a roughness of at least about 200 μin. Rₐ.

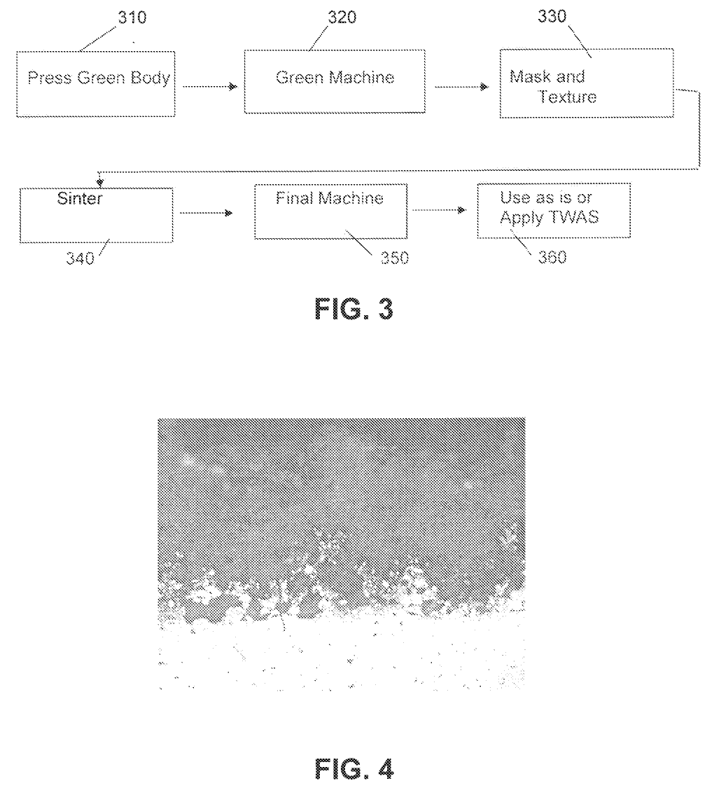

Referring to FIG. 3, there are shown the basic steps of an embodiment of the process for providing a roughened ceramic surface on a ceramic component in accordance with this invention. In Step 310 a ceramic powder is isostatically pressed to form a green compact in the general shape of the desired component. Isostatic pressing can be carried out using either a wet-bag or a dry-bag technique.

In Step 320, the green compact is machined to near net shape by a green machining technique, for example, using a numerical control machine with carbide tooling. In Step 330, the surface of the machined green compact is textured using any of the techniques described below. Hard or soft masking may be applied to areas of the green compact that do not require a textured surface.

In Step 340, the textured ceramic layer is sintered to final or near-final form. After firing, the component may be further machined and/or flattened to meet the precise geometric requirements for the particular process kit application, as indicated in Step 350. The ceramic-coated component can be used as-is or a metal layer can be applied, such as by TWAS or plasma spray, as indicated in Step 360. The textured component surface does not need to be blasted with an abrasive prior to TWAS or plasma spray coating. The fired-in textured surface is useful even without being coated for process residue accumulation in the reactor chamber.

In actual trials, it has been possible to produce alumina ring and shield surfaces with roughnesses exceeding 900 μin Rₐ, and a range (peak to valley) exceeding 4000 μin as measured with a stylus profilometer.

The texturizing step 330 according to the present invention can be carried out in a number of different ways. In a first embodiment the green ceramic compact is blasted with spray dried spheres of high purity alumina or zirconia. That technique provides a combination of positive and negative texturing of the surface because it provides very small indentations on the surface, the negative texturing, and some of the ceramic spheres adhere to the surface, the positive texturing. In another embodiment, the green ceramic coating is textured by spraying a thick slip or slurry of high purity alumina or zirconia powder mixed with an acrylic or polyvinyl alcohol (PVA) binder onto the surface of the green ceramic. A dispersant is preferably included in the slip to facilitate spraying.

Spray guns typically have a 30 degree fan. In some cases the spray fan may be larger. When slurry spray and spray-dried particulate techniques are utilized for the green texturing process according to this invention, the roughness developed on the alumina surface can become branched as shown in FIG. 4. We have observed branched structures on textured zirconia surfaces with roughness greater than 600 uin Rₐ. Based on pull test data we have obtained, we have concluded that branch-type roughness does not benefit residue adhesion and may actually reduce adhesion strength of residues. Accordingly, it is preferred that the sprayed particles or slurry droplets be directed substantially normal to the green ceramic surface, not at an oblique angle to the ceramic surface.

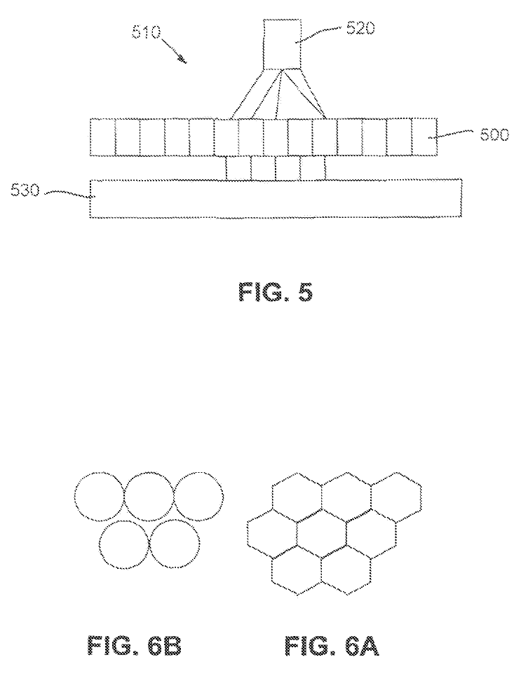

Referring now to FIG. 5, there is shown a physical collimator 500 that is used to filter droplets 510 from a spray nozzle 520 that are not traveling substantially normal to the surface 530 of a part to be textured. The collimator 500 acts as a filter to stop droplets that are traveling at an oblique angle from the spray nozzle. The collimator 500 is preferably embodied as a plate with holes in it. The collimator is positioned between the spray nozzle 520 and the substrate surface 530. The collimator preferably has holes with a hexagonal shape in cross section, as shown in FIG. 6A, although other geometries, such as circular holes may also be used, as shown in FIG. 6B. The plate is preferably about 1 to 3 inches thick.

Alternatively, the texturing is applied by brushing a thin slip of the alumina/zirconia plus acrylic/PVA mixture onto the surface of the green compact. A further technique for texturing the green ceramic is to plasma spray the green compact with a film consisting of 99% pure alumina, zirconia, or yttria. Another technique for texturing the green compact includes blasting the compact with a fine medium to provide a plurality of very small indentations on the surface of the green compact. Among the preferred media for this technique are high purity alumina spheres, high purity zirconia spheres, plastic spheres, glass beads, walnut shells, sugar, and corn husks. As a further alternative, the green ceramic material can be textured with a knurling device or with a hard bristle brush.

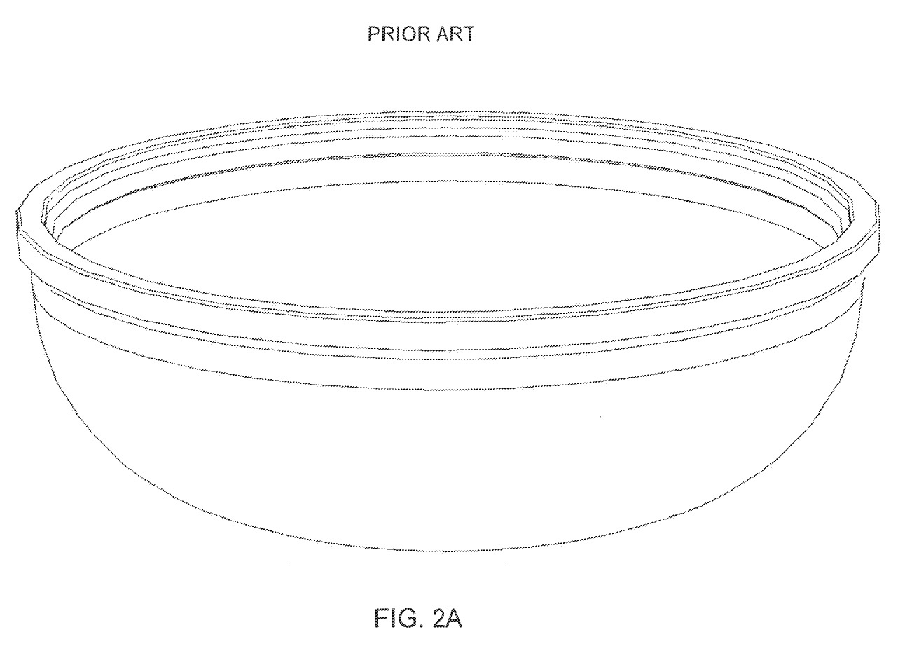

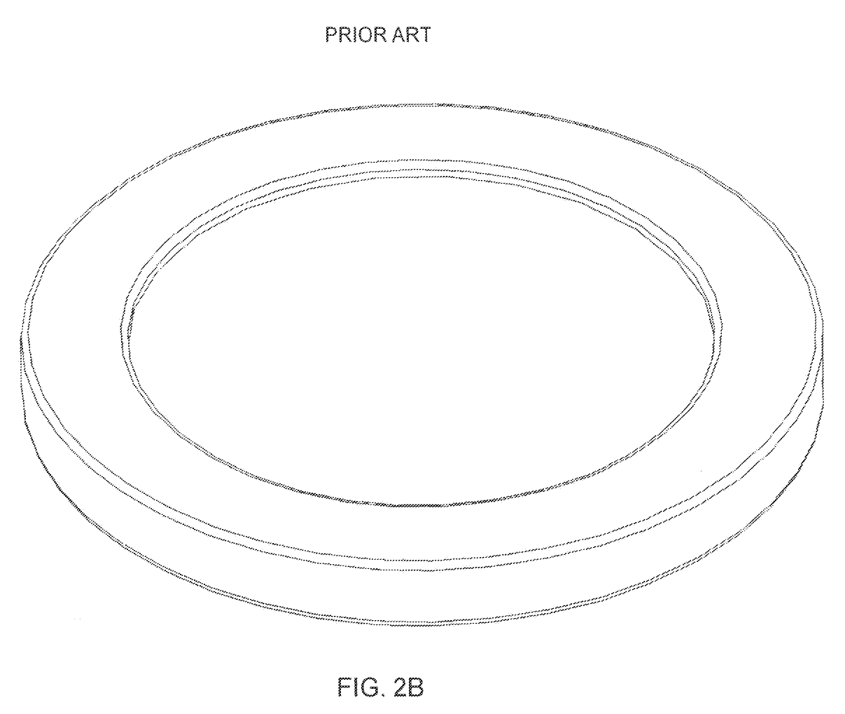

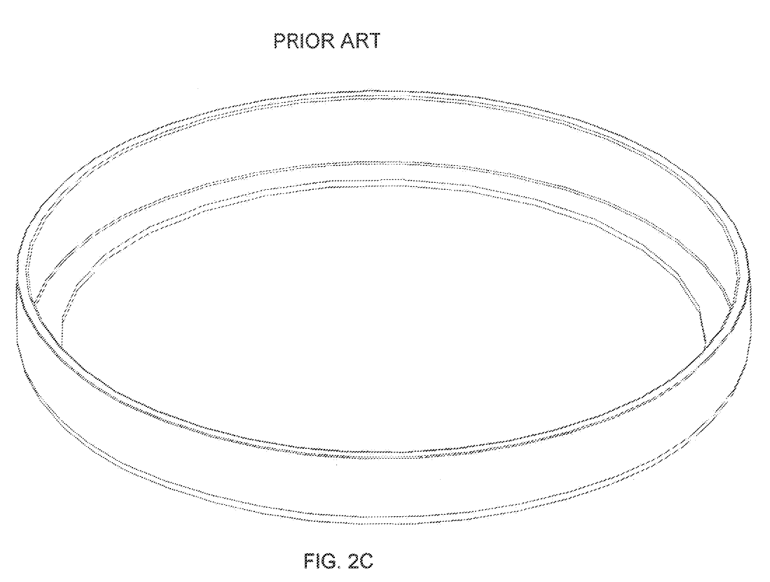

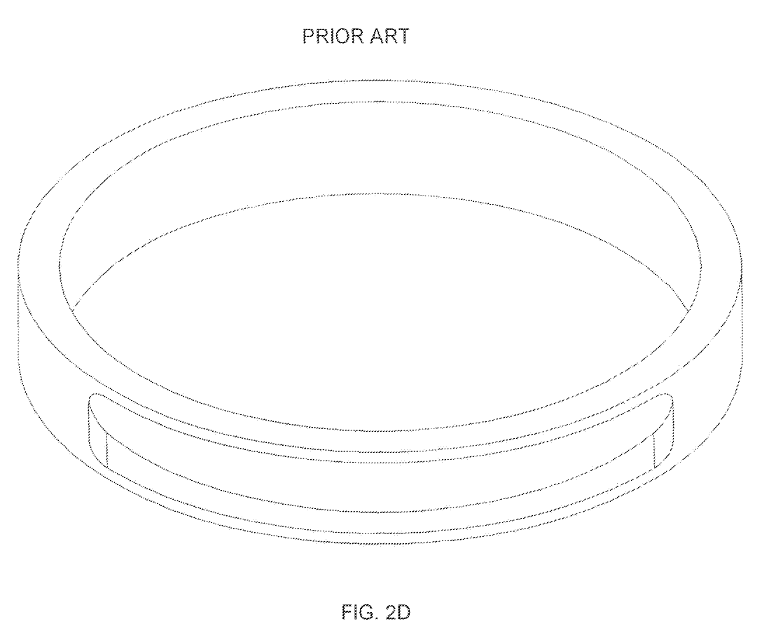

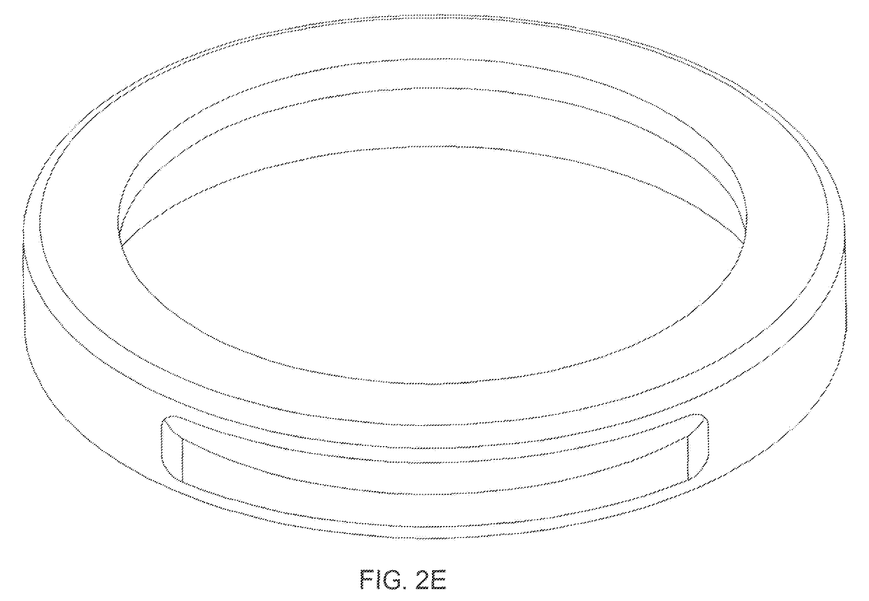

When carrying out any of the foregoing texturing techniques, a mask can be applied to the green ceramic material so that only a selected area of the surface is textured, as shown in FIG. 2E. The mask can be a soft mask such as tape or another flexible fabric applied to the surface of the green compact. Alternatively, a hard mask, for example, a plate or band made of metal or other hard material, can be positioned over the selected area. The textured surface can be removed preferentially by diamond grinding if masking is inadequate.

The target adhesion strength for TWAS or reactor residues is equal to or greater than the tensile strength of annealed Al, typically about 10,000 to 13,000 psi. Currently, TWAS adhesion to alumina is typically measured to be 3,000 to 5,000 psi using epoxy pull testing. Because of the chemical affinity of zirconia for Al, it is believed that TWAS adhesion to zirconia is approximately 5,000 to 7,000 psi. In actual experiments, we measured TWAS peel strengths exceeding 10,000 psi using samples prepared by the fired-in texturing process according to this invention. Sample surfaces made using the techniques described above typically provide a peel strength of at least 7,500 psi. Such high bond strength should increase reactor component service lifetimes by up to 300% by reducing the frequency of periodic cleaning.

Alumina- and zirconia-coated reactor components such as domes, shields, and cover rings, featuring fired surfaces that have been textured in the green state could potentially hold thicker process residues than components having surfaces coated with TWAS or plasma spray films alone. The adhesion strength of such intermediate films would no longer be a factor in component life, thus eliminating a “weak link in the chain”. CVD, PVD, and etch chamber residues adhere well to ceramics, and it is possible that adhesion strength can exceed 12,000 psi on an optimized surface. In addition, one could mask and deposit or bead blast the green ceramic surface itself, thereby generating both microscopic and macroscopic adhesion patterns. Shapes or patterns could be imaged into component surfaces thus improving management of compressive films generated as process byproducts. Textured patterns could consist of a grid or random patterns of dots, stars, ovals, or squared in the size range of 0.1 to 5 mm in diameter.

### EXAMPLE

Following is a prophetic example of the process according to the present invention. A spray dried alumina ceramic powder containing acrylic or PVA based binder is isostatically pressed to form a green compact in the form of a ring. The ring was formed with an outside diameter of 3 inches, an inside diameter of 0.75 inches, and a thickness of 0.5 inches. The green compact is formed by wet-bag isostatic pressing at pressures from 12000 to 16000 PSI, preferably 15,000 PSI, although a dry-bag process could also have been used.

After pressing, the green compact is machined to near net shape using a numerically controlled machine, such as a Hass CNC lathe, using conventional carbide tooling. Following machining, portions of the ring can be masked prior to texturing. The texturing process is completed inside a well ventilated industrial painting booth using commercially available automated equipment. In this example the ring is placed on a 26″ diameter industrial turntable at a 12″ radius. The source of texturing is an industrial grit blasting gun operating at pressures ranging from 40 to 80 PSI, preferably 60 PSI. Spray dried spheres of alumina of the same inorganic composition as the green compact (PVA or Acrylic binders), sized from −100 to +325 Mesh, preferably +230 mesh are placed in the material feed to the grit blasting gun. After the gun is loaded, it is positioned about 2 to 6 inches, preferably about 4 inches directly above the path of the component on the turntable. The blasting gun is swept from side to side up to 4 inches, using an oscillating support bracket. Oscillation rates can range from about 10 oscillations per minute to about 60 oscillations per minute. Preferably, the oscillation rate is about 20 oscillations per minute. The turntable than is turned on at 10 to 40 RPM, preferably about 5 to 10 RPM, and a solenoid valve is activated to supply air to the blasting gun. Spray dried alumina particles then impinge into the green component surface, some sticking and others bouncing away, thus creating a rough surface. Texturing is conducted for about 30 to 120 seconds, preferably for about 60 seconds. After texturing is competed, the air is turned off and the part is carefully removed from the turntable.

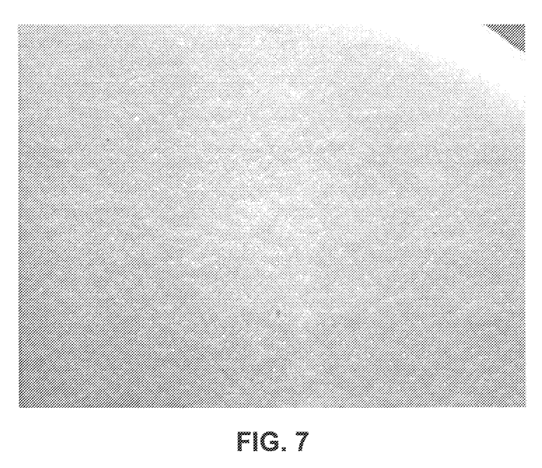

Next the textured ceramic layer is sintered at a temperature from 1500 to 1700° C. to near-final form using an industrial gas kiln. After firing, the surface roughness of the component can be characterized using an optical profilometer such as that sold by Wyco of Tucson, Ariz. or a stylus profilometer such as that sold by Mitutoyo of Japan. The textured component can be used as-is or machined further to provide more precise dimensions. Post-fired surface roughness ranges from 100 to 600 μin. Rₐ and are proportional to texturing time. FIG. 7 shows an as-fired surface of a ceramic component made by the process according to the present invention. The component surface has a uniform distribution of peaks and valleys and a surface roughness of at least about 100 μin Rₐ.

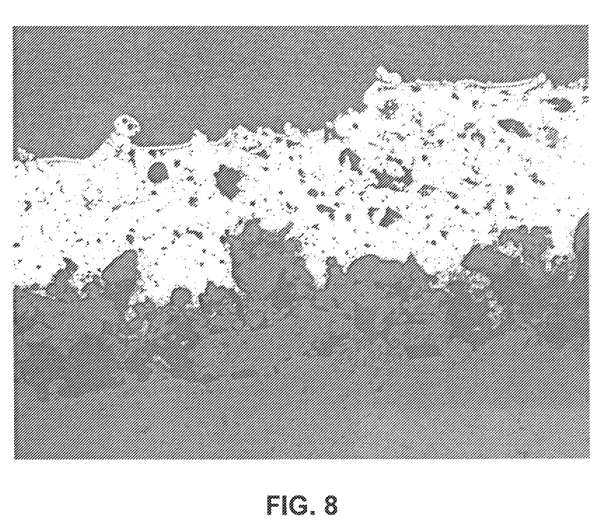

A secondary metal layer can be applied to the textured ceramic substrate, such as by TWAS or plasma spray, as indicated in Step 360. The textured component surface does not need to be blasted with an abrasive prior to TWAS or plasma spray coating. The fired-in textured surface is useful even without being coated for process residue accumulation in the reactor chamber. FIG. 8 shows a composite layer structure of a ceramic reactor component made in accordance with the present invention. The ceramic substrate 810 has a textured surface region 812. An aluminum layer 814 is deposited over the ceramic substrate 810 by the TWAS technique. An outer layer of tantalum 816 is formed over the aluminum layer 814 by PVD.

What is claimed is:

1. A method of improving adhesion of processing materials on a ceramic component comprising the steps of:
forming a green ceramic reactor component;
texturing the surface of the green ceramic component; and then firing the textured ceramic component to densify and harden it.

2. The method according to claim 1 wherein the texturing step comprises the step of blasting the surface of the green ceramic component with a texturing medium.

3. The method according to claim 2 wherein the texturing medium comprises fine, high purity ceramic spheres.

4. The method according to claim 3 wherein the ceramic spheres are formed of high purity alumina or high purity zirconia.

5. The method according to claim 2 the texturing medium is selected from the group consisting of alumina particles, zirconia particles, plastic spheres, glass beads, walnut shells, sugar, corn husks, and a combination thereof.

6. The method according to claim 1 wherein the texturing step comprises the step of knurling the surface of the green ceramic component.

7. The method according to claim 1 wherein the texturing step comprises the step of brushing the surface of the green ceramic component.

8. The method according to claim 1 wherein the texturing step comprises the step of applying a coating comprising a slip containing a ceramic powder and a binder.

9. The method according to claim 8 wherein the step of applying the coating comprises the step of brushing the surface of the green ceramic component with a thin slip containing the ceramic powder and the binder.

10. The method according to claim 8 wherein the step of applying the coating comprises the step of spraying the surface of the green ceramic component with a thick slip containing the ceramic powder and the binder.

11. The method according to claim 10 the spraying step comprises the step of spraying the coating through a collimator or filter

12. The method according to claim 8, 9, or 10 wherein the ceramic powder is high purity alumina powder or high purity zirconia powder.

13. The method according to any one of claims 1 to 11 comprising the step of applying a mask to the green ceramic component before carrying out the texturing step.

14. A method of improving adhesion of processing materials on a ceramic component comprising the steps of:
forming a green ceramic reactor component;
texturing the surface of the green ceramic component;
firing the textured ceramic component to densify and harden it; and then
coating the surface of the textured and fired ceramic component with a secondary adhesion layer.

15. The method according to claim 14 wherein the surface coating step comprises twin wire arc spraying (TWAS) a layer of aluminum onto the component surface to form the secondary adhesion layer.

16. The method according to claim 14 wherein the surface coating step comprises the step of plasma spraying a layer of a material selected from the group consisting of aluminum, yttria, zirconia, hafnia, and combinations thereof.

17. A component for use in an etching or deposition reactor chamber comprising:
a substrate formed of a ceramic material; and
a textured surface formed on said substrate wherein said textured surface has a roughness of about 100 to 1000 μin Rₐ.

18. The component as claimed in claim 17 wherein the component is a part selected from the group consisting of a ring, a dome, and a shield.

19. The component as claimed in claim 17 comprising a secondary adhesion layer formed on said textured surface.

20. The component as claimed in claim 19 wherein the secondary adhesion layer comprises a material selected from the group consisting of aluminum, yttria, zirconia, hafnia, and combinations thereof.

21. The component as claimed in claim 17 wherein said textured surface comprises indentations formed in the ceramic material.

22. The component as claimed in claim 17 wherein said textured surface comprises a layer of powdered ceramic material.

23. The component as claimed in claim 22 wherein the ceramic material comprises high purity alumina powder or high purity zirconia powder.
